(19) United States
(12) Patent Application Publication
(10) Pub. No.: US 2024/0283755 A1
(43) Pub. Date: Aug. 22, 2024

(54) METHOD FOR TRANSMITTING STRUCTURED DATA

(71) Applicant: Robert Bosch GmbH, Stuttgart (DE)

(72) Inventors: Santiago Pagani, Karlsruhe (DE); Benedikt Mendorf, Herrenberg (DE); Lutz Bornmann, Renningen (DE); Peter Hrenka, Reutlingen (DE); Peter Holtwick, Renningen (DE); Steffen Koenig, Leinfelden-Echterdingen (DE)

(21) Appl. No.: 18/581,823

(22) Filed: Feb. 20, 2024

(30) Foreign Application Priority Data
Feb. 21, 2023 (DE) 10 2023 201 497.1

(51) Int. Cl. H04L 49/901; H04L 12/40; H04L 49/9015

(52) U.S. Cl. CPC H04L 49/901; H04L 12/40123; H04L 49/9015

(57) ABSTRACT

A method for transmitting structured data between a data-transmitting module and a data-receiving module. The structured data are structured as data blocks. The method uses a memory region for storing the data using the data-transmitting module and for reading the data using the data-receiving module to transmit data from the data-transmitting module to the data-receiving module. Data blocks in each case include a first field with an address, and at least one further field for storing links to further data blocks, so that a list of interlinked data blocks can be formed. An access data memory stores a start pointer to a first data block of the list and stores an end pointer to a last data block of the list.

### FIELD

The present invention relates to a method for transmitting structured data between a data-transmitting module and a data-receiving module.

### BACKGROUND INFORMATION

Whenever distributed access to data containers, such as lists, arrays, or vectors, which are in a shared memory region to which various data processing modules (threats/runnables) have access takes place, great care must be taken because collisions of read accesses and write accesses can easily take place, which can lead to incorrect memory states. A conventional approach to avoiding such collisions is the use of so-called locks. Locks are flags that can selectively forbid individual data processing modules from read access or write access. However, the use of locks can lead to considerable performance losses because locking the access by locks normally hinders further data processing by the respective modules during the time of the lock.

An object of the present invention is to provide a method to perform the exchange of data between two data processing modules with very high performance and high security.

The method is in particular suitable for being used in the context of highly automated driving. In this context, very large amounts of data are regularly exchanged between various data processing modules, which are, for example, each different filters for processing data from surroundings sensors of a motor vehicle.

With the method according to the present invention described here, a special list is to be presented which can be operated without the use of locks and to which distributed access is possible.

### SUMMARY

The present invention relates to a method for transmitting structured data between a data-transmitting module and a data-receiving module,
wherein the structured data are structured as data blocks, and the method uses a memory region for storing the data by means of the data-transmitting module and for reading the data by means of the data-receiving module in order to transmit data from the data-transmitting module to the data-receiving module,
wherein data blocks are in each case designed with a first field with an address, and with at least one further field (2, 3) for storing links to further data blocks, so that a list of interlinked data blocks can be formed,
wherein furthermore an access data memory stores a start pointer to a first data block of the list and for storing an end pointer to a last data block of the list,

wherein, for storing data by means of the data-transmitting module, data blocks are first filled independently of the list and are subsequently added to the list by adjusting pointer memories in data blocks of further fields (2, 3) and by adjusting the access data memory, wherein the access data memory is adjusted with an atomic operation, the execution of which cannot be interrupted by other operations.

It is important for the method of the present invention described herein that the filling of the data blocks is completed before linking of the data blocks via the access data memory to further blocks takes place.

Data blocks are written independently of adding the blocks to the list. Writing data blocks takes time. Adding them to the list takes place very quickly. The list as a whole does not have to be locked for all accessing data-transmitting modules/data-receiving modules, because filling the data blocks takes place separately (outside) of the list and adding the data blocks to the chain takes place with the atomic operation, which cannot be interrupted by other operations.

In this respect, the described method of the present invention can be performed in a lock-free manner, i.e., without locks, because no locks are necessary at the level of creating and updating the list. In principle, only the access data memory is decisive for the list. All other parts of the list (such as the content of the data blocks, and in particular the links of the data blocks of the list to one another) takes place at a different level. For this reason, work on the list can take place in a lock-free manner.

The method of the present invention is, in principle, also wait-free, i.e., without waiting times, because each process (the data-transmitting module and the data-receiving module) can access the access data memory at any time without restrictions since the access data memory is only modified with atomic operations.

The method of the present invention provides a list which can be operated on a shared memory region without locks and to which distributed access by various data processing modules is possible.

This becomes possible through the special structure of the list and the described method steps of the present invention as well as the use of so-called atomic operations for the critical step of adding or deleting data blocks to the list or from the list.

A linked list usually consists of data blocks with two or three fields. A first field contains the actual data of the data block or a pointer to these data. A second field contains a pointer to the next data block and, optionally, there is also a third field, which contains a pointer to the previous data block. In the case of lists that contain only one pointer to the next data block in each case, reference is made to so-called singly linked lists. In the case of lists that contain pointers both to the previous data block and to the next data block, reference is made to so-called doubly linked lists.

Furthermore, the list preferably has an access data memory which contains a pointer to the first data block of the list and, optionally, a pointer to the last data block of the list as well as, optionally, a memory for the length of the list. Starting from the access data memory, the entire list can then be run through forward or backward from data block to data block by means of the pointers.

In conventional lists, new data blocks are first added to the list and then filled with the data.

In the method of the present invention described here, the data blocks are preferably first provided independently of the list. In principle, data blocks can also always exist independently of whether or not they are part of the list. The data blocks are preferably defined beforehand. Preferably, a data block pool is provided for the method described here, which data block pool is also referred to as mempool, which provides a fixed number of, for example, N maximally available data blocks, which are all suitable for being part of the list. Each of these data blocks can be attached to the list via its indices/references in the second field and the third field and thus become a list node or can also be detached from the list again by changing the indices/references.

The maximum number of elements of the list is optionally limited by the size of the mempool. However, it is also possible that the mempool can be increased dynamically (during runtime) so that the maximum size of the list is, in principle, not limited.

The special trick by which the list described here becomes operable in a lock-free manner is the use of atomic operations for certain actions for adding or separating data blocks to/from the list. The approach described here according to the present invention can in principle be used both for doubly linked lists and for singly linked lists, wherein the principle is explained here on the basis of the doubly linked list, the singly linked list representing a simplification thereof.

Atomic operations are characterized in that they are not interrupted by other processes on a processor on which the different modules (data-transmitting module and data-receiving module) are operated. Such atomic operations thus form the smallest unit of an executable program on the processor. A conventional processor used for the method described herein provides a plurality of atomic operations. An atomic operation that is able to compare a data set to another data set and then to update a data set on the basis of the comparison result is particularly important here. Such an atomic operation is generally also referred to as “atomic compare exchange.”

According to an example embodiment of the present invention, adding data blocks to the list preferably takes place in multi-stage processes, wherein the critical step is the atomic operation, which is however prepared and which may also fail if changes to the access data memory have occurred in the meantime that were not yet apparent during the preparation of the atomic operation. Preferably, the process which is to add data blocks to the list first copies the content of the access data memory and stores it as access data memory copy in a secure memory region, where other processes cannot impair the access data memory copy. A new access data memory data set is then created on the basis of the data sets to be added to the list and on the basis of the access data memory or on the basis of the access data memory copy (which is identical to the access data memory in terms of content). In addition, in the data blocks to be added to the list and in the first data block of the list, the second field and the third field are changed such that the data block to be added, or the new list node, is already set before the first data block of the list with regard to the assignments of the second field and of the third field. Once these preparations have been completed, it is checked with the atomic operation “atomic compare exchange” whether the access data memory copy still matches the access data memory and if so, the content of the access data memory is overwritten with the new access data memory data set. If the access data memory copy no longer matches the access data memory, another process has accessed the access data memory and changed it. In this case, the access data memory copy is newly created and the process starts again until the new data block is successfully added to the list.

It is particularly advantageous if, when data are stored by the data-transmitting module, one or more data blocks are already linked to one another, independently of the list, by means of pointers stored in the further fields, to form a new sublist before adding to the list takes place.

Preferably, any complex sublists can be generated outside the list, which sublists can then be added to the list or to the access data memory in a (single) step with the atomic operation.

The normal case of the method described according to the present invention is adding one data block after the other. The formation of sublists (subchains of different lengths) before adding to the list with the atomic operation is a special design variant of the described method.

Data-receiving modules can only access the added data blocks when the access data memory has been updated by the atomic operation. For this reason, the added subchain is invisible to data-receiving modules before the atomic operation is carried out. After adjusting the access data memory, this data block becomes visible. After deleting a data block from the list by an atomic operation, this data block continues to be visible to data-reading modules that currently access this block. Only when the entry point to the list is again retrieved via the access data memory does this block become invisible to the data-reading module. While a data block is being read, a lock can also be set on this block. However, this does not change the fact that the list itself is lock-free and that other data processing modules can already simultaneously work on the list again.

It is also advantageous if one or more data blocks are in principle added to the list at a first data block or a last data block of the list.

This specification achieves that data blocks cannot be inserted within the list. This specification makes it possible for the entry point into the list for all processes to be modified entirely via the change in the access data memory.

It is preferred if the specification is so specific that data blocks can always only be added either at the front (at a first end) or at the rear (at a second end) of the list.

According to an example embodiment of the present invention, it is also preferred if, for removing data blocks from the list, the access data memory is adjusted with an atomic operation. In principle, the atomic operation “atomic compare exchange” can also be used for this purpose, wherein an access data memory copy is first generated and the new access data memory data set is subsequently prepared and is then used with the operation “atomic compare exchange” to update the access data memory.

If all data blocks are removed from the list, or the list is emptied, an atomic data deletion operation can alternatively also be used, which assigns values that define an empty list to the access data memory.

Furthermore, according to an example embodiment of the present invention, it is preferred if a removal of data blocks from the list in principle takes place starting from a first data block or a last data block by adjusting the access data memory with an atomic operation.

It is also advantageous if the data-receiving module reads the data blocks of the list in blocks, wherein each data block has a lock memory in which the data-receiving module sets a reservation as long as the data are being read.

Here, locks are thus set for reading data from the individual data block of the list. Since adding data blocks to the list is however still possible despite the lock on the individual data block and in light of the fact that the deletion of data blocks is also still possible, locks at the block level do not influence the basic functionality of the list as lock-free.

Furthermore, according to an example embodiment of the present invention, it is advantageous if data blocks removed from the list initially continue to exist after removal from the list and are released in a subsequent step for deleting the data blocks if no reservation is set in a lock memory.

Since sufficient data blocks are preferably provided in the described mempool, which data blocks can be added to the list as required with the method described, maintaining a reservation of a data block after removal from the list is possible without problems.

Even if data blocks have been removed from the list, processes that currently read or process these data blocks can still access these data blocks. However, processes that want to retrieve the current state of the list can no longer see these data blocks.

According to an example embodiment of the present invention, it is also advantageous if each data block has a further second field and a further third field, wherein a pointer in a second field links the data block to a data block arranged further toward the front of the list, wherein a pointer in a third field links the data block to a data block arranged further toward the rear of the list.

According to an example embodiment of the present invention, a data processing system comprising a data-transmitting module and a data-receiving module and a memory region is also to be described here, wherein the data processing system is configured to transmit data from the data-transmitting module to the data-receiving module according to the method described.

The data processing system is particularly preferred if the data processing system is part of a system for the highly automated driving operation of a motor vehicle.

It should be noted that the special advantages and design features described in connection with the method according to the present invention described above can also be applied and transferred to the device described below.

Also to be described here is a computer program product that is configured to carry out the described method of the present invention, which computer program product can in particular be executed with the data processing system described here. A storage medium on which such a computer program product is stored is also to be described.

The method and the technical environment of the method of the present invention are explained in more detail below with reference to the figures. The figures show preferred exemplary embodiments of the present invention, to which the method is not limited. It should be noted, in particular, that the figures and in particular the size proportions shown in the figures are only schematic.

### BRIEF DESCRIPTION OF THE DRAWINGS

FIGS. 1A and 1B show examples of lists used with the method according to the present invention described.

FIGS. 2A-2D show a first example of adding data blocks to a list according to the present invention.

FIGS. 3A-3E show a first example of adding data blocks to a list, according to the present invention.

FIGS. 4A-4D show a first example of adding data blocks to a list, according to the present invention.

FIGS. 5A-5D show first example of adding data blocks to a list, according to the present invention.

FIG. 6 shows a data processing system with which the described method is carried out.

### DETAILED DESCRIPTION OF EXAMPLE EMBODIMENTS

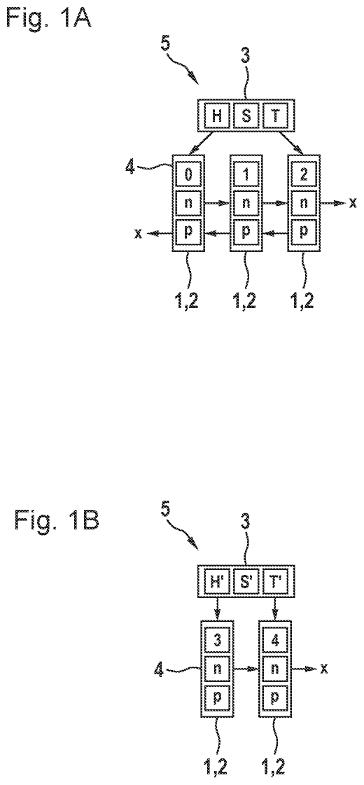

FIG. 1A and FIG. 1B show the basic structure of the lists 5 that can be used for the method described here; FIG. 1A shows a doubly linked list 5. FIG. 1B shows a singly linked list 5.

The data blocks 1 that have been added to the list 5 and in each case form list nodes 2 of the list 5 can be seen in each case. Three values are stored in the access data memory 3. “H” stands for head or the beginning of the list. “T” stands for tail or the end of the list, and “S” stands for the length of the list.

The list 5 can be accessed via the access data memory 3. Via the access data memory 3, a data-receiving data processing module can access first the beginning or the end of the list 5 and, via it, all data blocks 1 or list nodes 2 in the list 5.

Each data block 1 contains a first field 4, which here, by way of example, contains a number as an address to the relevant data block 1 and which stands for the data contained in the relevant data block 1. Each data block 1 also has a second field n and a third field p, in which pointers 17 to the following data block 1 and to the previous data block 1 in the list 5, respectively, are stored, which data blocks also respectively form list nodes 2. Data blocks 1 that are not linked via pointers 17 to the access data memory 3 directly or indirectly via further data blocks 1 do not form list nodes 2 and are not part of the list.

It is important for the method described here that, in the first data block 1 of the list 5, the third field p, which is provided to point to a preceding data block 1 of the list 5, is unused or undefined. Likewise, in the last data block 1 of the list 5, the second field n, which is provided to point to a following data block 1 of the list, is unused or undefined. For this reason, links to further data blocks 1 that are not yet part of the list 5 but are to be added as list nodes 2 to the list 5 can be inserted here, without this leading to a change in the list 5 from the point of view of a data-receiving data processing module. A lock is not required in this case.

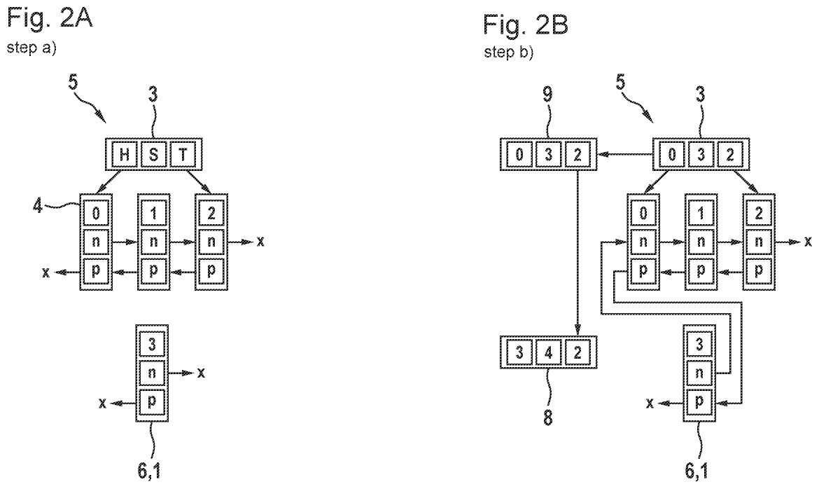

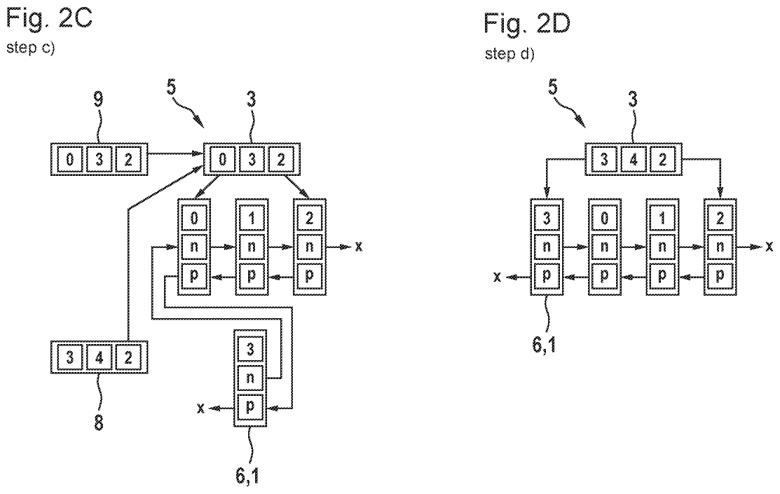

FIG. 2A to 5D now show various data processing operations with which data blocks 1 can be added as list nodes 2 to the list 5 or can be deleted from the list 5. In FIGS. 2A to 5D, by way of example, simple indices for data sets, pointers 17 and addresses are used in each case, which are used to explain the method and do not restrict the disclosure. Actual pointers 17, indices and addresses can be different and in particular adapted to the respective surroundings (operating system) on which the list 5 is operated.

FIGS. 2A-2D for example, shows the situation in which a data block 1 is to be added as a new list node 6 to the list 5.
Step a) (FIG. 2A) shows that the new data block 1 is first filled with data externally (without said data block being connected to the list 5) so that a new list node 6 is prepared.
Subsequently, in step b) (FIG. 2B), the pointers 17 in the third field p of the first data block 1 of the list 5 and in the second field n of the data block 1 to be added are adjusted so that the data block 1 to be added or the new list node 6 is already filled so that it is inserted into the list 5. Since the third field p of the first data block 1 of the list 5 is undefined, this third field p can simply be adjusted here without having to consider other processes that access the list 5. Access by other processes to the list 5 takes place only via the access data memory 3. In this case, the third field p of the first data block 1 of the list 5 is irrelevant. Furthermore, in step b) (FIG. 2B), a new access data memory data set 8 is prepared, which becomes applicable when the new list node 6 is added to the list 5. For this purpose, an access data memory copy 9, which is stored securely in such a way that other processes cannot access it, is first created of the access data memory 3. The new access data memory data set 8 is subsequently created on the basis of the data taken from the access data memory 3. It can be seen here that the assignment (first list node=0, list length=3, last list node=2) of the access data memory 3 is updated to the assignment (first list node=3, list length=4, last list node=2).
Step c) (FIG. 2C) is the critical step of adding the new list node 6 to the list 5. For carrying out the method described, it is essential that step c) (FIG. 2C) is carried out with a so-called atomic operation, which is carried out in a processor for carrying out the method as a whole so that no further processes can interrupt the execution of the atomic operation. Used here is an atomic operation that is able to compare a data set to another data set and then to update a data set on the basis of the comparison result. Such an atomic operation is generally also referred to as “atomic compare exchange.” With this operation, the assignment of the access data memory 3 is compared to the assignment of the securely stored access data memory copy 9. Only if it is found here that the assignment of the copy of the access data memory 9 still corresponds to the access data memory 3, the access data memory 3 is overwritten with the new access data memory data set 8 within the atomic operation. It is important for the described method that the described atomic operation “atomic compare exchange” is used here, because this ensures that the new list node 6, prepared as in step b) (FIG. 2B), is directly added to the lists 5 only if other processes have not changed the list 5 in the meantime.
In step d) (FIG. 2D), the list 5 is now expanded by the new list node 6.

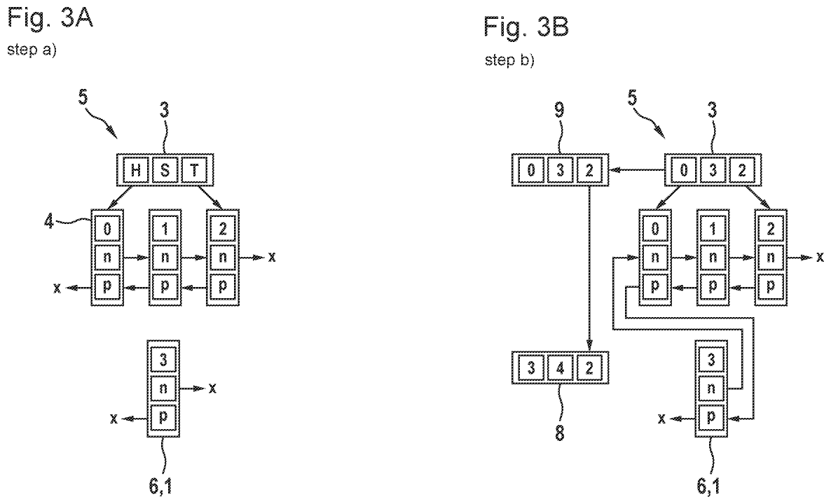

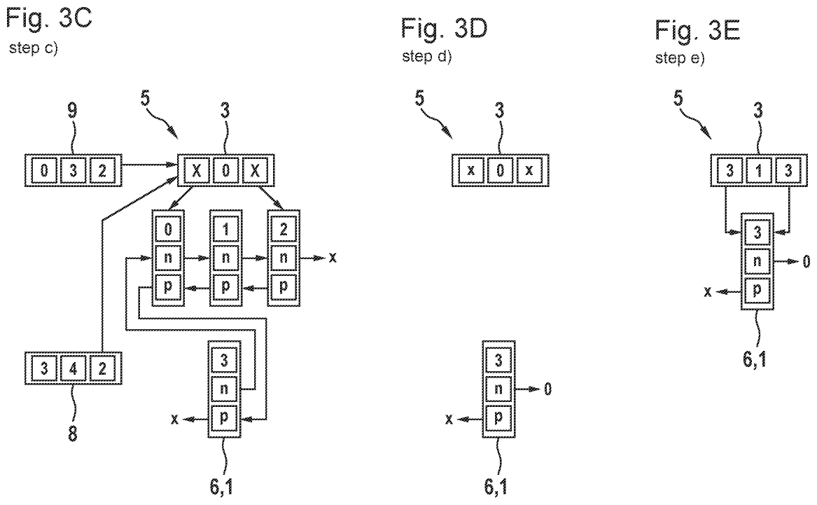

FIGS. 3A-3E now shows the same sequence, which is also described in FIGS. 2A-2D. However, the difference here is that the atomic operation “atomic compare exchange” in step c) (FIG. 3C) fails. As a result, deviations occur starting from step c) (FIG. 3C), which are described below:
In step c) (FIG. 3C), the atomic operation “atomic compare exchange” fails, for example because, in the meantime, another process has accessed the list 5 and completely deleted the list 5. The comparison of the access data memory 3 to the securely stored access data memory copy 9 has the result that equality no longer exists. The access data memory 3 is not updated with the new access data memory data set 8 already prepared in step b) (FIG. 3B).
For this reason, the access data memory 3 is checked again in step d) (FIG. 3D). In this case, it is determined that the list 5 is now empty. The access data memory 3 has the following assignment (first list node=X=not assigned, list length=0, last list node=X=not assigned).
Now, according to step e) (FIG. 3E), the list 5 is completely newly constructed with the new list node 6 as the sole data set 1 in the list 5 and the following assignment of the access data memory 3 (first list node=3, list length=1, last list node=3). The pointer 17 stored in field n of the new list node 6 in step b) (FIG. 3B) to the former first list node 2 of the list 5 “0” is present but not relevant, because this field n is not defined for the list 5. The value in the second field n of the last list node 2 of the list 5 is not taken into account and can simply remain as an undefined value in the list node 2.

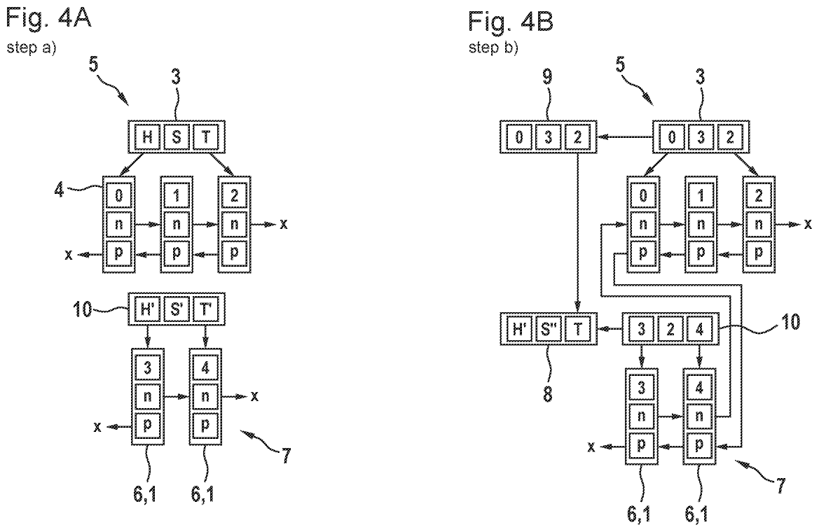

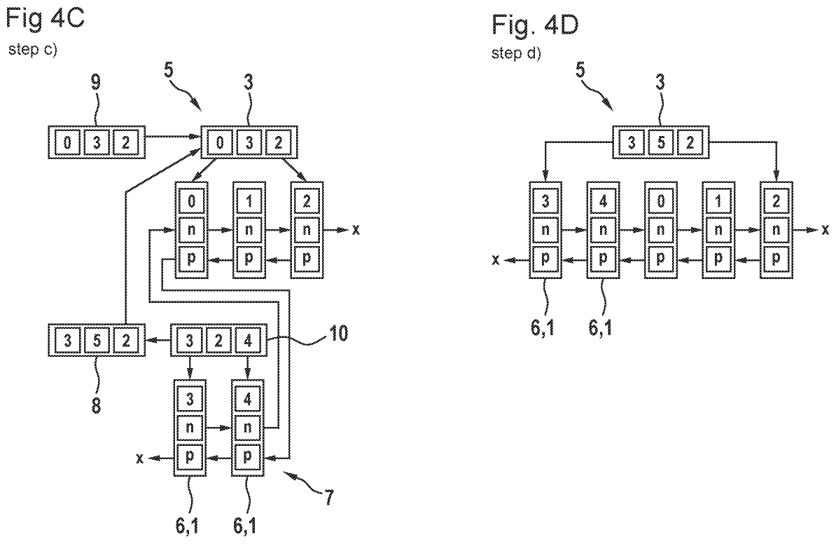

FIGS. 4A-4D show the special case that not only a single new list node 6 is to be added to the list 5, but rather a separate new sublist 7 consisting here of two new list nodes 6 or of two data blocks 1.
The new sublist 7 is prepared here according to step a) (FIG. 4A) without any existing connection to the list 5. The sublist 5 preferably has its own sublist access data memory 10.
According to step b) (FIG. 4B), just as according to FIGS. 2B and 3B, the creation of the access data memory copy 9 and the generation of the new access data memory data set 8 then take place on the basis of the access data memory 3 and the sublist access data memory 10. The first list node 2 of the supplemented list 5 corresponds to the first new list node 6 of the new sublist 7. The list length of the supplemented list 5 corresponds to the sum of the list lengths of the original list 5 and of the new sublist 7. The assignment of the new access data memory data set 8 is thus as follows (first list node=3, list length=5, last list node=2). In addition, the second field n of the last new list node 6 of the new sublist 7 and the third field p of the first list node 2 of the list 5 are adjusted in preparation of later adding the new sublist 7 to the list 5.
In step c) (FIG. 4C), the atomic operation “atomatic compare exchange” is carried out in order to add the new sublist 7 to the list 5. This operation is successful here as also in the variant shown in FIG. 2C.
In step d) (FIG. 4D), the list 5 with the two new list nodes 6 thus results from the new sublist 7.

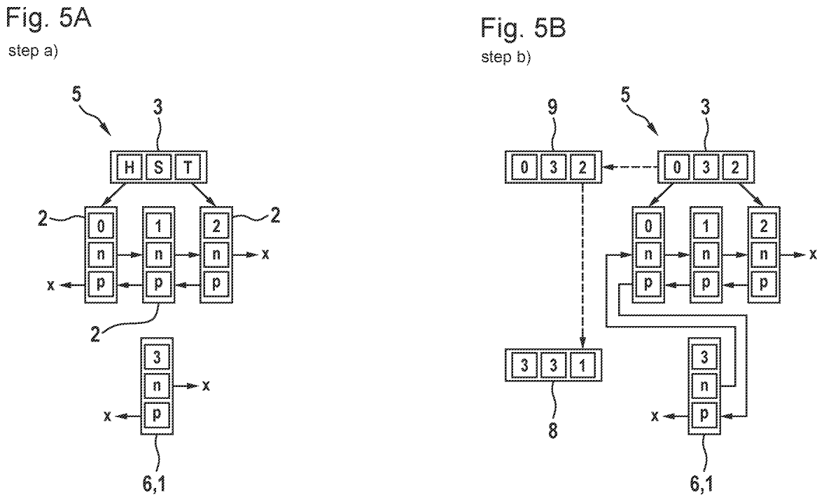

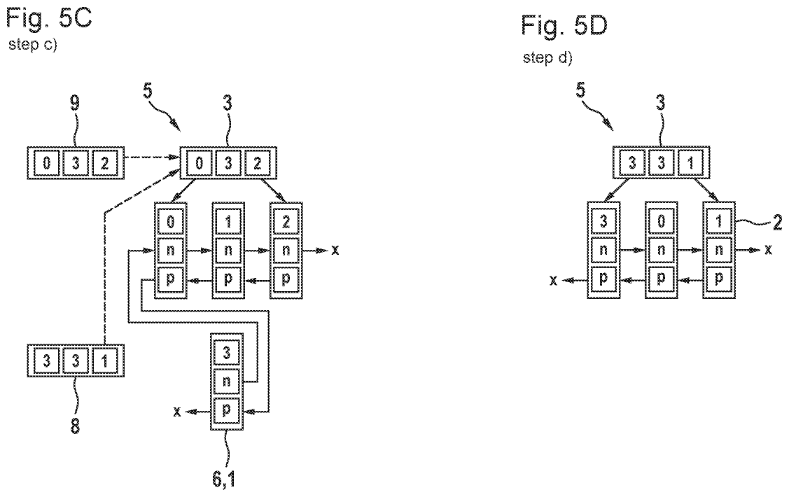

FIGS. 5A-5D show a special addition to the described method, namely the addition that the list 5 has a fixed length, which is here, for example, fixed to three list nodes 2. If a new list node 6 is added at the beginning of the list 5, a list node 2 must also always be deleted from the list 5 at the end of the list so that the length of the list 5 remains constant and, in the example here, corresponds to three list nodes 2. In the following, only the (minor) differences of the method sequence according to FIGS. 5A-5D from the method sequence according to FIGS. 2A-2D, 3A-3E, and 4A-4D are described. Otherwise, for explaining FIGS. 5A-5D, reference is made to the explanations relating to FIGS. 2A-2D, 3A-3E, and 4A-4D and in particular to FIGS. 2A-2D.
Step a) (FIG. 5A) takes place just as according to FIGS. 2A, 3A and 4A.
In step b) (FIG. 5B), the second field n of the new list node 6 is adjusted, wherein the third field p of the first list node 2 of the list 5 is adjusted just as according to FIGS. 2B, 3B, and 4B. The access data memory copy 9 is created. The new access data memory data set 8 is generated somewhat differently than according to FIGS. 2B, 3B, and 4B. With knowledge of the fixed list length (here three list nodes), the address in the first field 4 of the list node 2 of the list 5 that will be the new last list node 2 of the list 5 after adding the new list node 6 is ascertained. This is the address “1” here. This results in the following assignment for the new access data memory data set 8 (first list node=3, list length=3, last list node=1).
In step c) (FIG. 5C), the access data memory 3, and thus the list 5, is adjusted with the atomic operation “atomic compare exchange.”

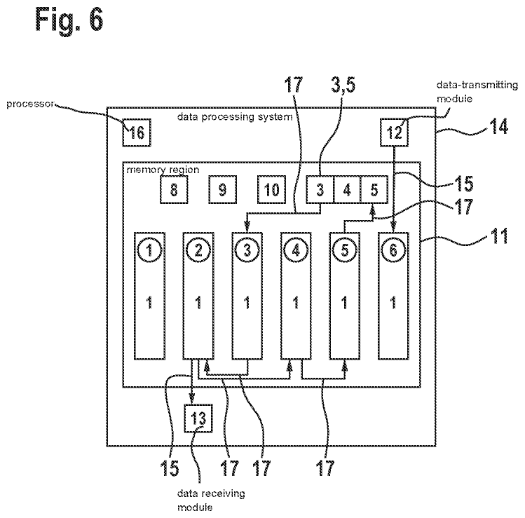

FIG. 6 shows a data processing system 14, which is provided for carrying out the described method. The data processing system 14 has a data-transmitting module 12 and a data-receiving module 13 and a memory region 11 to which the data-transmitting module 12 and the data-receiving module 13 respectively have unlimited access and in which data are to be exchanged without data locks (in a lock-free manner) between the data-transmitting module 12 and the data-receiving module 13 with the described method. The data processing system 14 also has at least one processor 16 on which the processes are executed. Processes here are in particular the data-transmitting module 12 and the data-receiving module 13, which are executed on the processor 16 or which execute commands that can be executed by the processor 16, which commands change the memory region 11. The processor 16 provides a plurality of operations, namely, in particular, also atomic operations. For carrying out the described method, it is essential that the processor 16 provides an atomic operation for exchanging a data set in the access data memory, which operation makes it possible to check the content of the access data memory and to exchange the content for the new data set only if the content matches an expected content (atomic compare exchange).

FIG. 6 shows that data blocks 1 and the access data memory 3 are provided in the memory region 11. Of six data blocks 1 shown by way of example here, four data blocks 1 are part of the list 5. The six data blocks 1 shown here form the mempool referred to above, in which the list 5 is provided. Via the access data memory 3, the first data block 1 of the list 5 can be accessed, which is here the data block 1 with the index “3.” The data blocks 1 in the list 5 are all linked to one another via pointers 17. The index “5” of the last data block 1 of the list 5 and the length of the list 5, which consists of four data blocks here, are stored in the access data memory 3.

The actual filling of the data blocks 1 takes place externally to the list 5 and is here indicated with the data transfer 15 from the data-transmitting module 12 to the data-receiving module 13. The data-receiving module 13 reads the data from the data blocks 1 after the data-receiving module 13 has ascertained via the access data memory 3 which data blocks 1 are to be read. Data blocks 1 that are currently being read can be blocked by a lock. However, this does not impair the possibility of changing the list 5 by means of the data-transmitting module 12. Data blocks 1 can be deleted from the list 5 by changing the access data memory 3, without this being impaired by a lock on the individual data block 1. The data-receiving module 13 can nevertheless continue to read the data block 1. Only if precisely this data block 1 is to be filled again later is a release of the data block 1 by the data-receiving module 13 necessary. So that the described method is executed smoothly, it is important that sufficient data blocks 1 are available so that new list nodes 6 can always be prepared as data blocks 1 outside the list 5 before the new list nodes 6 or data blocks 1 are added to the list 5 with an atomic operation relating to the access data memory 3.

1-12. (canceled)

13. A method for transmitting structured data between a data-transmitting module and a data-receiving module, wherein the structured data are structured as data blocks, and the method uses a memory region for storing the structured data using the data-transmitting module and for reading the structured data using the data-receiving module to transmit data from the data-transmitting module to the data-receiving module, wherein the data blocks each include a first field with an address, and at least one further field for storing links to further data blocks, so that a list of interlinked data blocks can be formed, and wherein an access data memory is provided for storing a start pointer to a first data block of the list and for storing an end pointer to a last data block of the list, the method comprising the following step:
storing data using the data-transmitting module by first filling data blocks with the data independently of the list, and subsequently, after filling the data blocks, adding the filled data blocks to the list by adjusting pointer memories in the further fields of certain of the data blocks and adjusting the access data memory, wherein the access data memory is adjusted with an atomic operation, wherein an execution of the atomic operation cannot be interrupted by other operations.

14. The method according to claim 13, wherein, when the data are stored by the data-transmitting module, the filled data blocks are linked to one another, independently of the list, by pointers stored in the further fields of the filled data blocks, to form a new sublist before adding to the list takes place.

15. The method according to claim 13, wherein one or more data blocks are added to the list at a first data block of the list or a last data block of the list.

16. The method according to claim 13, the method further comprising:
removing certain of the data blocks from the list by adjusting the access data memory with an atomic operation.

17. The method according to claim 16, wherein the removal of the certain data blocks from the list takes place starting from a first data block or a last data block by adjusting the access data memory with an atomic operation.

18. The method according to claim 16, wherein the data-receiving module reads the data blocks of the list in blocks, wherein each of the data blocks of the list has a lock memory in which the data-receiving module sets a reservation as long as the data of the data block are being read.

19. The method according to claim 18, wherein those of the data blocks that are removed from the list initially continue to exist after removal from the list and are released in a subsequent step for deleting the those data blocks when no reservation is set in the lock memory of the those data blocks.

20. The method according to claim 13, wherein each data block has a further second field and a further third field, wherein a pointer in the second field of the data block links to a data block arranged further toward a front of the the list, wherein a pointer in the third field of the data block links to a data block arranged further toward a rear of the list.

21. A data processing system, comprising:
a data-transmitting module;
a data-receiving module; and
a memory region;
wherein the data processing system is configured to structured data between the data-transmitting module and the data-receiving module, wherein the structured data are structured as data blocks, and the memory region is used for storing the data using the data-transmitting module and for reading the data using the data-receiving module to transmit data from the data-transmitting module to the data-receiving module, wherein data blocks each include a first field with an address, and at least one further field for storing links to further data blocks, so that a list of interlinked data blocks can be formed, and wherein an access data memory is provided for storing a start pointer to a first data block of the list and for storing an end pointer to a last data block of the list, wherein the data processing system is configured to:
store data using the data-transmitting module by first filling data blocks with the data independently of the list, and subsequently, after filling the data blocks, adding the filled data blocks to the list by adjusting pointer memories in the further fields of certain of the data blocks and adjusting the access data memory, wherein the access data memory is adjusted with an atomic operation, wherein an execution of the atomic operation cannot be interrupted by other operations.

22. The data processing system according to claim 22, wherein the data processing system is part of a system for highly automated driving operation of a motor vehicle.

23. A non-transitory computer-readable storage medium on which are stored commands for transmitting structured data between a data-transmitting module and a data-receiving module, wherein the structured data are structured as data blocks, and the method uses a memory region for storing the structured data using the data-transmitting module and for reading the structured data using the data-receiving module to transmit data from the data-transmitting module to the data-receiving module, wherein the data blocks each include a first field with an address, and at least one further field for storing links to further data blocks, so that a list of interlinked data blocks can be formed, and wherein an access data memory is provided for storing a start pointer to a first data block of the list and for storing an end pointer to a last data block of the list, the commands, when executed by a computer, causing the computer to perform the following step:
storing data using the data-transmitting module by first filling data blocks with the data independently of the list, and subsequently, after filling the data blocks, adding the filled data blocks to the list by adjusting pointer memories in the further fields of certain of the data blocks and adjusting the access data memory, wherein the access data memory is adjusted with an atomic operation, wherein an execution of the atomic operation cannot be interrupted by other operations.
